(19) United States
(12) Patent Application Publication
(10) Pub. No.: US 2010/0055241 A1
(43) Pub. Date: Mar. 4, 2010

(54) FENUGREEK SEED HAVING REDUCED BITTER TASTE AND METHOD FOR PRODUCING THE SAME

(76) Inventors: Yuki Nakano, Osaka (JP); Shohei Hoshino, Osaka (JP); Jinji Shono, Osaka (JP); Nobuaki Tsuge, Osaka (JP)

Correspondence Address: BIRCH STEWART KOLASCH & BIRCH, PO BOX 747, FALLS CHURCH, VA, 22040-0747, US

(21) Appl. No.: 12/450,906

(22) PCT Filed: Apr. 18, 2008
(86) PCT No.: PCT/JP2008/057998

§ 371 Date: Oct. 16, 2009

(30) Foreign Application Priority Data
Apr. 19, 2007 (JP) 2007-110570
Oct. 22, 2007 (JP) 2007-274021

(51) Int. Cl. A23L 1/36; A23L 1/211

(52) U.S. Cl. 426/44; 426/629

(57) ABSTRACT

It is an object of the present invention to obtain fenugreek seeds having reduced bitter taste without causing significant changes in non-bitter components contained in fenugreek seeds.

The present invention relates to a method for producing fenugreek seeds having reduced bitter taste, comprising allowing β-glucosidase to act on an eluate in which the components of fenugreek seeds have been eluted and then allowing the fenugreek seeds to absorb the eluate and β-glucosidase, and a food containing such fenugreek seeds.

### TECHNICAL FIELD

The present invention relates to fenugreek seeds having reduced bitter taste that can be used as a useful spice, a method for producing the same, and a food containing such fenugreek seeds.

### BACKGROUND ART

Fenugreek is an annual leguminous plant. Fenugreek seeds are known to have been used for long time for traditional spices such as curry powder.

Fenugreek seeds are known to contain bitter components. It has been reported in Non-Patent Document 1 that a main bitter component contained in fenugreek seeds is protodioscin, which is a furostanol saponin. Meanwhile, fenugreek seeds contain a variety of useful components. For example, Patent Document 1 discloses that fenugreek seeds contain 4-hydroxyisoleucine (4-OH-Ile). 4-OH-Ile is known to be useful for treatment of insulin resistance (Patent Document 2).

A long-established method for removing a bitter component from fenugreek seeds is a method wherein fenugreek seeds are immersed in water and water is changed repeatedly such that a bitter component contained in the fenugreek seeds is eluted into water, which results in bitter taste reduction. However, this method has a serious drawback in that it causes loss of non-bitter components (in particular, 4-OH-Ile and the like, which are called functional components) upon removal of a bitter component.

In addition, regarding a method for reducing a saponin compound that is contained as a bitter component in white asparagus and palmyra palm (Borassus flabellifer L.), a method wherein β-glucosidase is allowed to act has been suggested (Non-Patent Documents 2 and 3). However, Non-Patent Document 2 does not suggest the removal of a bitter component alone while maintaining the form of the whole or a portion of a plant and functional components of the plant. Further, flabelliferin, which is a bitter component of palmyra palm described in Non-Patent Document 3, is structurally different from any bitter component contained in fenugreek seeds. Therefore, it is impossible to understand whether or not the bitter taste of fenugreek seeds can be removed based on Non-Patent Document 3.

Patent Document 1: US Patent Application No. 2004/0009247

Patent Document 2: JP Patent Publication (Kohyo) No. 2003-508435 A

Non-Patent Document 1: “Main bitter components of fenugreek (Masamura)” published by the Japan Society for Spice Research (Nihon Kōshinryō Kenkyūckai), 1999

Non-Patent Document 2: Agric. Biol. Chem., 41(1), 1-8, 1977 “Isolation and Structure of Furostanol Saponin in Asparagus Edible Shoots”

Non-Patent Document: 3 J Sci Food Agric 1994, 65, 185-189 “Studies on the Bitter Principle and Debittering of Palmyrah Fruit Pulp”

### DISCLOSURE OF THE INVENTION

It is an object of the present invention to obtain fenugreek seeds having reduced bitter taste without causing significant changes in non-bitter components contained in fenugreek seeds.

In addition, it is another object of the present invention to provide a food containing the above fenugreek seeds.

The present inventors have made the surprising finding that the bitter taste of fenugreek seeds can be reduced by allowing β-glucosidase to act on an eluate obtained by eluting fenugreek seed components with water. Further, the present inventors have found that when the fenugreek seeds are allowed to absorb such eluate and β-glucosidase, it results in substantially no loss of water-soluble useful components eluted from the fenugreek seeds, such as 4-OH-Ile. More specifically, at the time of filing of this application, the main bitter component contained in fenugreek seeds was thought to be protodioscin, which is a furostanol saponin (Non-Patent Document 1). There is an assumption that the above mechanism of bitter taste reduction involves β-glucosidase-induced degradation of a saponin compound serving as a bitter component contained in an eluate, resulting in the removal of bitter taste. However, the scope of the present invention is not limited to such assumption. In addition to a bitter component, the above eluate contains water-soluble useful components such as 4-OH-Ile. Such useful components are not substantially degraded by β-glucosidase treatment. Based on this fact, the present inventors have found that it has become possible to produce fenugreek seeds having reduced bitter taste while substantially retaining useful components by allowing fenugreek seeds to absorb an eluate subjected to β-glucosidase treatment with the use of the water absorption capacity inherent in the seeds. The present inventors have completed the following inventions based on the above findings.

(1) A method for producing fenugreek seeds having reduced bitter taste, comprising the steps of: adding water to fenugreek seeds so as to elute the components of the fenugreek seeds; adding β-glucosidase; and allowing the fenugreek seeds to absorb the components and the β-glucosidase.
(2) The method according to (1), comprising the steps of: adding water to the fenugreek seeds so as to form a mixture; eluting the components of the fenugreek seeds in the water contained in the mixture; adding β-glucosidase to an eluate obtained by eluting the components in the water contained in the mixture; and allowing the fenugreek seeds to absorb the eluate and β-glucosidase contained in the eluate.
(3) The method according to (1), comprising the steps of: immersing fenugreek seeds in water by adding water thereto; eluting the components of the fenugreek seeds in the water; separating the fenugreek seeds from an eluate obtained by eluting the components in the water; adding β-glucosidase to the separated eluate; and allowing the fenugreek seeds to absorb the eluate and β-glucosidase contained in the eluate.
(4) The method according to any one of (1) to (3), wherein the step of eluting the components of fenugreek seeds is a step of heating a mixture obtained by adding water to fenugreek seeds.
(5) The method according to any one of (1) to (3), wherein the step of adding β-glucosidase is a step of adding β-glucosidase to the eluate or a step of preliminarily adding β-glucosidase to fenugreek seeds and/or water.
(6) The method according to any one of (1) to (3), wherein the amount of water added is 30 to 600 parts by weight based on 100 parts by weight of fenugreek seeds.
(7) The method according to any one of (1) to (3), wherein the amount of water added is 60 to 400 parts by weight based on 100 parts by weight of fenugreek seeds.
(8) The method according to any one of (1) to (3), further comprising drying the fenugreek seeds absorbing the eluate and β-glucosidase after allowing β-glucosidase to act.
(9) The method according to any one of (1) to (3), further comprising deactivating β-glucosidase after allowing β-glucosidase to act.
(10) A food comprising, as a raw material, fenugreek seeds produced by the method according to any one of (1) to (9).

This description includes part or all of the contents as disclosed in the descriptions and/or drawings of Japanese Patent Application Nos. 2007-274021 and 2007-110570, which are priority documents of the present application.

### BRIEF DESCRIPTION OF THE DRAWINGS

FIG. 1A is a photograph showing a cross section of a fenugreek seed.

FIG. 1B schematically shows the cross-sectional structure of a fenugreek seed.

FIG. 2 is a photograph showing results obtained in Example 3.

FIG. 3 shows exterior photographs of an untreated seed, a seed obtained in Example 5, and a seed obtained in Example 4.

FIG. 4 shows photographs indicating staining results (spot staining results for a seed extract obtained with the addition of water in an amount of 30 parts by weight) in Example 8.

FIG. 5 shows images indicating staining results obtained in Example 12.

FIG. 6 shows images indicating staining results obtained in Example 13.

### BEST MODE FOR CARRYING OUT THE INVENTION

### 1. Fenugreek Seeds

Fenugreek seeds used as raw materials in the present invention are untreated seeds, such as unpulverized seeds. In addition, such seeds include seeds that have germinated after immersion (germinated seeds).

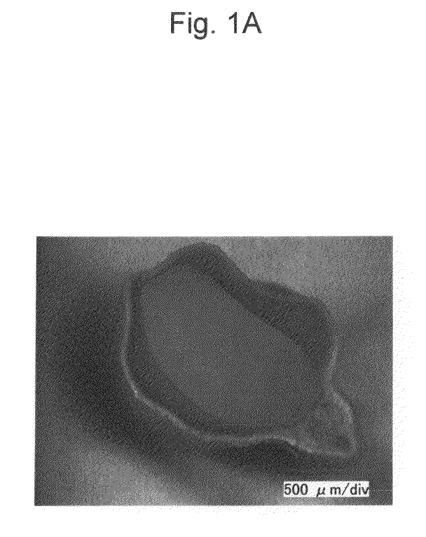

FIG. 1A is a photograph showing a cross section of a fenugreek seed. FIG. 1B schematically shows the cross-sectional structure of a fenugreek seed. As shown in 1B, each fenugreek seed has a structure in which a cotyledon is located in the center portion, the cotyledon is surrounded by a layer mainly consisting of galactomannan, and the surface of the galactomannan layer is covered with a seed coat.

The moisture content of fenugreek seeds to be used is not particularly limited. However, the moisture content is preferably approximately 8% to 12% by mass and most preferably approximately 10% by mass.

### 2. Fenugreek Seeds and an Eluate

The method of the present invention comprises the steps of: adding water to fenugreek seeds so as to elute the components (e.g., saponin) of the fenugreek seeds; adding β-glucosidase; and allowing the fenugreek seeds to absorb the components and the β-glucosidase. Further, the method of the present invention comprises the steps of eluting the components (e.g., saponin) of fenugreek seeds by adding water to fenugreek seeds; allowing β-glucosidase to act on the eluted components; and then allowing the fenugreek seeds to absorb the eluate and β-glucosidase.

Fenugreek seeds can absorb water in amounts at least 3 times greater than the amounts thereof. With the use of such absorption capacity, fenugreek seeds are allowed to absorb an eluate containing β-glucosidase and fenugreek seed components on which β-glucosidase have acted. There are two such specific methods. The methods are separately described below.

A first method comprises the steps of: adding water to fenugreek seeds so as to form a mixture; eluting the components of the fenugreek seeds in the water contained in the mixture; adding β-glucosidase to an eluate obtained by eluting the components in the water contained in the mixture; and allowing the fenugreek seeds to absorb the eluate and β-glucosidase contained in the eluate.

In another embodiment, the method comprises the steps of: forming a mixture by adding water to fenugreek seeds; eluting the components of the fenugreek seeds in the water contained in the mixture; allowing β-glucosidase to act on an eluate obtained by eluting the components in the water contained in the mixture; and then allowing the fenugreek seeds to absorb the eluate and β-glucosidase contained in the eluate.

A second method comprises the steps of: immersing fenugreek seeds in water by adding water thereto; eluting the components of the fenugreek seeds in the water; separating the fenugreek seeds from an eluate obtained by eluting the components in the water; adding β-glucosidase to the separated eluate; and allowing the fenugreek seeds to absorb the eluate and β-glucosidase contained in the eluate.

In another embodiment, the method comprises the steps of: immersing fenugreek seeds in water by adding water thereto; eluting the components of the fenugreek seeds in the water; separating the fenugreek seeds from an eluate obtained by eluting the components in the water; allowing β-glucosidase to act on the separated eluate; and then allowing the fenugreek seeds to absorb the eluate and β-glucosidase contained in the eluate.

These methods use a technique whereby fenugreek seed components can be recovered by allowing such seeds to absorb an eluate having reduced bitter taste that contains components subjected to enzyme treatment. The technique is based on the fact that there is a time lag because fenugreek seed components are quickly eluted in water while it takes many hours to cause fenugreek seeds to absorb water. β-glucosidase and the eluate in which the components are eluted are recovered by means of the absorption capacity of fenugreek seeds. When active β-glucosidase is recovered by fenugreek seeds, an uneluted bitter component contained in the fenugreek seeds can be treated by the recovered β-glucosidase, resulting in further bitter taste reduction.

In a method for allowing β-glucosidase to act on fenugreek seeds, β-glucosidase is allowed to act on fenugreek seeds, for example, by adding β-glucosidase to water to be added, followed by mixing, by adding water and then adding β-glucosidase, followed by mixing, or by adding β-glucosidase to fenugreek seeds, followed by mixing.

Fenugreek seeds can absorb and retain large amounts of water mainly in their galactomannan layers.

In the first method, water is added to fenugreek seeds to form a mixture, and the fenugreek seed components are eluted in water contained in the mixture. At such time, depending on the amount of water, a certain portion of water is absorbed by fenugreek seeds and nonabsorbed water remains outside the fenugreek seeds (in a case in which the amount of water is relatively great). Alternatively, water is substantially completely absorbed inside fenugreek seeds (in a case in which the amount of water is relatively low). In the former case, an eluate containing the components of fenugreek seeds exists inside and outside the seeds. In the latter case, an eluate containing the components of fenugreek seeds mainly exists inside the seeds.

The first method encompasses both of these embodiments. In the first method, the amount of water is not particularly limited as long as it is 30 parts by weight or more based on 100 parts by weight of fenugreek seeds. However, when it is 1000 parts by weight or more, the amount of β-glucosidase to be used becomes large. In view of the above, in one example, the amount of water is 30 to 1000 parts by weight (preferably 30 to 600 parts by weight, more preferably 60 to 400 parts by weight, and further preferably 200 to 300 parts by weight) based on 100 parts by weight of fenugreek seeds. In particular, in a case in which the amount of water is preferably 30 to 500 parts by weight and more preferably 200 to 300 parts by weight, it is preferable to use a method wherein water is substantially completely absorbed by the fenugreek seeds.

In the second method, water is added to fenugreek seeds such that the fenugreek seeds are immersed therein. Therefore, a certain amount of water is absorbed by fenugreek seeds and the nonabsorbed water remains outside the fenugreek seeds. In one example, the amount of water in the second method is 30 to 1000 parts by weight (preferably 30 to 600 parts by weight, more preferably 300 to 700 parts by weight, and further preferably 300 to 600 parts by weight) based on 100 parts by weight of fenugreek seeds.

Major examples of a method for eluting fenugreek seed components (including a bitter component) include a method comprising maintaining a mixture of fenugreek seeds and water at ordinary temperatures for long time so as to elute a bitter component in water and a method comprising heating a mixture of fenugreek seeds and water such that a bitter component is eluted in water in a relatively short period time. For instance, heating is preferably carried out at 80° C. to 100° C. for 1 to 20 minutes. Accordingly, bitter taste reduction is effectively carried out as a result of the action of β-glucosidase. In addition, heating can cause advantageous effects such as sterilization and inhibition of generation of a specific grassy smell due to deactivation of an enzyme contained in fenugreek seeds. In addition, it is preferable to adjust the amount of the mixture after completion of the heating to 120 to 600 parts by weight (preferably 200 to 400 parts by weight) based on 100 parts by weight of fenugreek seeds mixed therein.

Further, it is preferable to lightly agitate fenugreek seeds in water to such an extent that the seeds at higher positions and those at lower positions are exchanged in their positions. This is because if agitation is carried out too strongly, seeds are destroyed, resulting in poor appearance.

### 3. β-Glucosidase

β-glucosidase used in the present invention may be derived from a microorganism, a plant, or the like, and is not particularly limited. However, the use of microorganism-derived β-glucosidase is preferable in terms of the intensity of enzyme activity and substrate compatibility. Examples of microorganisms include Trichoderma reesei (Trichoderma reesei RUT-C30 (ATCC No. 56765) and Trichoderma reesei QM9414 (ATCC No. 26921)). An example of plant-derived β-glucosidase is almond-derived β-glucosidase.

In addition, an enzyme preparation containing β-glucosidase can be used as β-glucosidase instead of purified β-glucosidase. Examples of an enzyme preparation include microorganism-derived Multifect BGL, SPEZYME CP (Genencor Kyowa), and naringinase (Tanabe Seiyaku Co., Ltd.). Multifect BGL and SPEZYME CP (Genencor Kyowa) are liquid enzyme preparations, and naringinase is a powdered enzyme preparation. Preferably, such an enzyme preparation contains a dietary-fiber-degrading enzyme such as mannanase in addition to β-glucosidase. Such dietary-fiber-degrading enzyme may be cellulase.

The amount of β-glucosidase to be added is not particularly limited. However, for example, when SPEZYME CP is used as a β-glucosidase-containing enzyme preparation, 0.001 ml to 20 ml of SPEZYME CP is preferably added to 20 g of fenugreek seeds. Alternatively, when SPEZYME CP is used as a β-glucosidase-containing enzyme preparation, 0.001 ml to 20 ml of SPEZYME CP may be added to 1 g of fenugreek seeds.

### 4. Enzyme Reaction

Further, in the method of the present invention, β-glucosidase is allowed to act, preferably followed by drying.

First, in the above first method, β-glucosidase is added to a mixture of fenugreek seeds and an eluate that can be obtained by immersing fenugreek seeds in water such that the β-glucosidase is allowed to act on the eluate containing a bitter component (a saponin compound). As a method for allowing β-glucosidase to act, a method comprising adding β-glucosidase to such eluate or preliminarily adding β-glucosidase to fenugreek seeds and/or water can be used. For instance, in a case in which β-glucosidase is added to the eluate, β-glucosidase is allowed to act on the eluate containing a large amount of a fenugreek seed component eluted therein. In addition, in a case in which β-glucosidase is preliminarily added to fenugreek seeds and/or water, fenugreek seed components are eluted in water to which β-glucosidase has been added such that β-glucosidase is allowed to act therein. The present invention also encompasses a method comprising the steps of: adding water to fenugreek seeds; adding β-glucosidase before fenugreek seed components are eluted in the water added; and allowing β-glucosidase to act while eluting the components of the fenugreek seeds.

An eluate contains a variety of water-soluble components such as 4-hydroxy isoleucine (hereinafter referred to as 4-OH isoleucine) in addition to a bitter component. A bitter component (a saponin compound) in such eluate is degraded by β-glucosidase; however, the other water-soluble components are not degraded. Then, fenugreek seeds are allowed to absorb the eluate and β-glucosidase, followed by drying according to need. Upon drying, the entire mixture in which β-glucosidase has been allowed to act may be subjected to drying. Alternatively, the mixture in which β-glucosidase has been allowed to act may be separated into a nonabsorbed portion of the eluate that exists outside the fenugreek seeds and the fenugreek seeds that have absorbed the eluate and β-glucosidase, followed by drying of the separated fenugreek seeds. In other cases, the dried fenugreek seeds are immersed in the separated eluate and allowed to absorb the eluate, followed by drying. By repeating the above step, it has become possible to allow fenugreek seeds to completely absorb a variety of water-soluble components. As described above, there is another method comprising adding a small amount of water to fenugreek seeds such that no eluate exists outside the fenugreek seeds.

Next, in the above second method, after immersion of fenugreek seeds, fenugreek seeds that have absorbed water and an eluate (immersion solution) are separated from each other. β-glucosidase is added to the separated eluate so as to allow β-glucosidase to act such that a bitter component (a saponin compound) in the eluate is degraded. Subsequently, the eluate in which β-glucosidase has been allowed to act and the separated fenugreek seeds are mixed again such that the eluate is absorbed by the seeds, followed by drying according to need. The above method is advantageous in that the appearances of seeds are unlikely to be damaged. The separation means is not particularly limited. An example of a method for mixing an eluate in which β-glucosidase has been allowed to act with fenugreek seeds is a method comprising immersing fenugreek seeds in such eluate and allowing fenugreek seeds to absorb the eluate. In addition, in this method, it is not necessary to cause the full amount of the eluate to be absorbed. For instance, fenugreek seeds may be immersed in an eluate on which β-glucosidase has acted and maintained for a certain time period such that the seeds are allowed to absorb the eluate. Then, a portion of the eluate that has not been absorbed by the seeds may be discarded, followed by drying of the seeds that have absorbed the immersion solution. In addition, it is also possible to use a method comprising repeating the steps of immersing the above dried fenugreek seeds again in the residual portion of the eluate that has not been absorbed by the fenugreek seeds (without discarding the residual portion of the eluate that has not been absorbed by the fenugreek seeds) such that the fenugreek seeds absorb the residual portion of the eluate and drying the fenugreek seeds. In order to increase the amount of an eluate to be absorbed by the seeds, the water absorption step is preferably carried out at a temperature of 45° C. to 55° C.

In the case of either the first method or the second method, an enzyme reaction is preferably carried out at 25° C. to 60° C. When the temperature exceeds 60° C., the activity of β-glucosidase might decrease. The pH upon reaction is preferably the optimum pH of an enzyme. Since the optimum pH would vary depending on the temperature, it is preferable to adequately adjust pH in accordance with temperature conditions.

Preferably, an enzyme that has been used to exhibit desired functions is deactivated by heating in order to avoid other effects. Such deactivation is preferably carried out at 90° C. or less. For instance, conditions of heating at 90° C. for 15 minutes are applicable. In addition, it is preferable to deactivate an enzyme by heating prior to drying treatment.

As a drying method, a hot-air drying method is preferably used. The hot air temperature can be 55° C. to 90° C. Alternatively, a lyophilization method may be used as a drying method. The reference level of the moisture content after drying is 12% by mass or less and preferably 2% to 10% by mass.

### 5. Usage

The fenugreek seeds of the present invention can be appropriately used for food as in the cases of other leguminous plants that are used as cereals contained in cooked rice, raw materials for sweets, and the like. In addition, the fenugreek seeds of the present invention can be used for a spice in a powdered form or a mixed spice that is a mixture of the fenugreek seeds of the present invention and different spices. Alternatively, an extract obtained by extraction or a powder obtained from an extract can be used as a health food material and the like.

### Example 1

### Removal of Bitter Taste from Seeds by Heating and Determination of 4-OH Isoleucine Content

### (Production of Seeds Having Reduced Bitter Taste)

Water (120 g) was boiled in a pan and fenugreek seeds (produced in India) (20 g) were added thereto, followed by heating in boiling water for 5 minutes. Then, the amount of water in the pan was finely adjusted so as to obtain a heated mixture in a weight of 69 g. After the addition of water, SPEZYME CP (Genencor Kyowa) (1.9 ml) was added to the mixture. After the addition of SPEZYME CP, incubation was carried out in a thermostatic water bath at 35° C. for 3 hours. During incubation, the obtained product in the pan was agitated with a spatula at hourly intervals. After incubation, the seeds removed from the immersion solution were heated in an autoclave at 90° C. for 15 minutes for deactivation of SPEZYME CP and then cooled, followed by hot-air drying at 60° C. for 2.5 hours.

### (The Degree of Water Absorption of Seeds)

In the above operation, the seeds absorbed 80% of water added thereto.

### (Sensory Evaluation of Bitter Taste)

The obtained seeds (10 g in terms of dry weight) were added to polished rice (1 cup: 180.39 cc) and cooked. As a control sample, untreated fenugreek seeds (10 g) were added to polished rice (1 cup) and cooked. Five grains were removed from each cooked rice sample containing seeds and subjected to sensory evaluation. Five panelists evaluated the bitterness intensity of the treated sample compared with the bitter taste of the control sample via a pair test. Regarding evaluation criteria, when the bitterness intensity of the treated sample was significantly lower than that of the control sample at a critical rate of 5%, it was determined that the bitter taste had been reduced. As a result, each of the five panelists judged that the bitterness intensity of the treated sample was stronger than that of the control sample. The results showed that there had been a significant difference between the samples at a critical rate of 0.1% determined via a pair test.

### (Changes in Appearance)

When fenugreek seeds were treated under the above conditions, there was no significant deterioration of appearance.

### (Analysis of 4-OH-Ile)

4-OH-Ile was extracted from the enzyme-treated seeds with the use of 70% ethanol. For comparison, untreated seeds were pulverized in 70% ethanol for extraction of 4-OH-Ile. Each extract was assayed by HPLC (Agilent 1100 series, 1100 HPLC, Agilent) according to a free amino acid analysis method. Consequently, the results listed in table 1 were obtained, indicating that there had not been any significant changes in the 4-OH-Ile content.

TABLE 1
Analysis value of 4-OH isoleucine
in fenugreek seeds (% by weight)

| | 4-OH-Ile content: Mean value | Standard deviation |
|---|---|---|
| | n = 2 (% by weight) | n = 2 (% by weight) |
| Original seeds | 0.64 | 0.0002 |
| Immersed seeds | 0.55 | 0.0014 |

### Example 2

### Removal of Bitter Taste from Seeds

### (Production of Seeds Having Reduced Bitter Taste)

Two samples were prepared by adding seeds (20 g) to tap water (58 ml). SPEZYME CP (1.9 ml) was added to one of the samples.

Each sample was agitated with a spatula and immersed in a thermostatic bath at 25° C. 47 hours after immersion, the seeds absorbed 80% of water added thereto.

### (Sensory Evaluation of Bitter Taste)

As a control sample, the immersed seeds in a similar manner without the addition of an enzyme were used. The panelists evaluated the bitter taste of each sample by tasting three immersed grains via their mouths. Among ten panelists, five were instructed to first examine the control sample and the other five were instructed to first examine the enzyme-treated sample in consideration of the order of effects. The panelists evaluated the bitterness intensity of the treated sample compared with the bitter taste of the control sample via a pair test. Regarding evaluation criteria, when the bitterness intensity of the treated sample was significantly lower than that of the control sample at a critical rate of 5%, it was determined that the bitter taste had been reduced. As a result, 9 out of 10 panelists judged that the bitterness intensity of the treated sample was weaker than that of the control sample. There was a significant difference between the samples at a critical rate of 5% determined via a pair test.

### Example 3

### Confirmation of Saponin Elution Upon Immersion

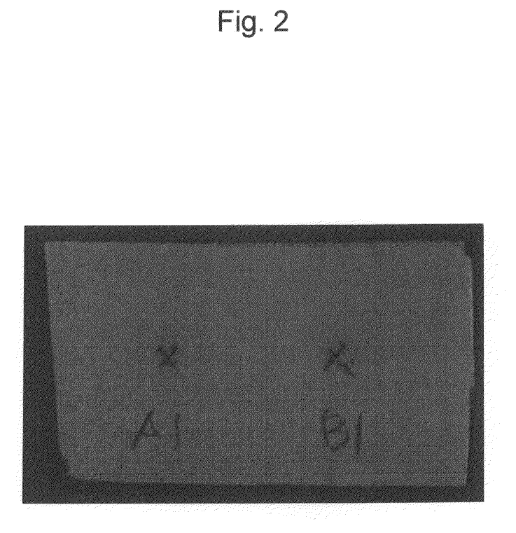

Two samples of fenugreek seeds (20 g each) were prepared. One of the samples was designated as an enzyme-treated sample, to which distilled water (4.1 ml) and an enzyme (SPEZYME CP: 1.9 ml) were added in such order, followed by mixing. The other sample was designated as a non-enzyme-treated sample, to which distilled water (6 ml) alone was added. Thereafter, each sample was allowed to stand at 35° C. 45 minutes thereafter, sampling from each sample was carried out. Then, the degree of saponin elution was confirmed by sensory evaluation and TLC. Herein, confirmation by TLC was carried out by spotting a solution containing furostanol saponin (1 μl) on a TLC plate (Silica gel 60F245, Merck 1.05715), followed by staining with an Ehrlich reagent. The Ehrlich reagent used was prepared by adding ethanol (80 ml) to 12 N hydrochloric acid (20 ml) and further adding dimethylaminobenzaldehyde (2 g) thereto. Furostanol saponin was stained red with the reagent unless saponin was degraded by β-glucosidase and decreased in amount. Upon sensory evaluation, the non-enzyme-treated sample had bitter taste; however, the enzyme-treated sample had no bitter taste. Based on TLC results shown in FIG. 2, elution of saponin from the non-enzyme-treated sample was confirmed. Meanwhile, elution of saponin from the enzyme-treated sample was confirmed to a slight extent. In view of the above, it is thought that saponin was eluted from the enzyme-treated sample; however, the sample was found to have no bitter taste upon sensory evaluation due to degradation of saponin by the enzyme SPEZYME CP.

### Example 4

### Removal of Bitter Taste from Seeds Treated to have an Increased Rate of Absorption of an Immersion Solution

### (Production of Seeds Having Reduced Bitter Taste)

Water (120 g) was boiled in a pan and fenugreek seeds (produced in India) (20 g) were added thereto, followed by heating in boiling water for 5 minutes. Then, the amount of water in the pan was finely adjusted so as to obtain a heated mixture in a weight of 73 g. After the addition of water, SPEZYME CP (Genencor Kyowa) (1.9 ml) was added thereto. After the addition of SPEZYME CP, incubation was carried out in a thermostatic water bath at 35° C. for 6 hours. During incubation, the obtained product in the pan was agitated with a spatula at hourly intervals. After incubation at 35° C., incubation was carried out in a thermostatic water bath at 45° C. for 1 hour. Then, a residual liquid portion that had not been absorbed by seeds was removed. The seeds removed from the immersion solution were heated in an autoclave at 90° C. for 15 minutes for deactivation of SPEZYME CP and then cooled, followed by hot-air drying at 60° C. for 2.5 hours.

### (The Degree of Water Absorption of Seeds)

In the above operation, the seeds absorbed 90% of water added thereto.

### (Sensory Evaluation of Bitter Taste)

The obtained seeds (9 g in terms of dry weight) were added to polished rice (2 cups: 360.78 cc) and cooked. As a control sample, untreated fenugreek seeds (9 g) were added to polished rice (2 cups) and cooked. Each of the cooked rice samples containing seeds was weighed and 1.7 g of each sample (6 grains) was subjected to sensory evaluation. Five panelists evaluated the bitterness intensity of the treated sample compared with the bitter taste of the control sample via a pair test. Regarding evaluation criteria, when the bitterness intensity of the treated sample was significantly lower than that of the control sample at a critical rate of 5%, it was determined that the bitter taste had been reduced. As a result, each of the five panelists judged that the bitterness intensity of the treated sample was weaker than that of the control sample. The results showed that there was a significant difference between the samples at a critical rate of 0.1% determined via a pair test.

### Example 5

### Reduction of Bitter Taste of Seeds Treated for Inhibition of Deterioration of Appearance

### (Production of Seeds Having Reduced Bitter Taste)

Water (120 g) was boiled in a pan and fenugreek seeds (produced in India) (20 g) were added thereto, followed by heating in boiling water for 5 minutes. After cooling, the resultant was separated into a liquid portion (16 ml) and water-absorbing seeds (48 g). The seeds were preserved in a refrigerator until the water absorption step. Thereafter, SPEZYME CP (Genencor Kyowa) (1.9 ml) was added to the obtained liquid portion, followed by incaution in a thermostatic water bath at 55° C. for 6 hours. Then, in the water absorption step, the seeds preserved in a refrigerator were added to the enzyme-treated liquid, followed by incubation in a thermostatic water bath at 45° C. for 1 hour. Thereafter, the residual liquid portion that had not been absorbed by the seeds was removed. After such water absorption, the seeds were subjected to steam heating at 90° C. for 15 minutes for deactivation of SPEZYME CP. The obtained seeds were cooled and subjected to hot-air drying at 60° C. for 2.5 hours.

### (Results)

Untreated seeds, seeds obtained in Example 5, and seeds obtained in Example 4 were compared in terms of bitter taste and appearance.

As a result of bitter taste evaluation, the bitter taste intensity was in the following descending order: untreated seeds, seeds obtained in Example 5, and seeds obtained in Example 4.

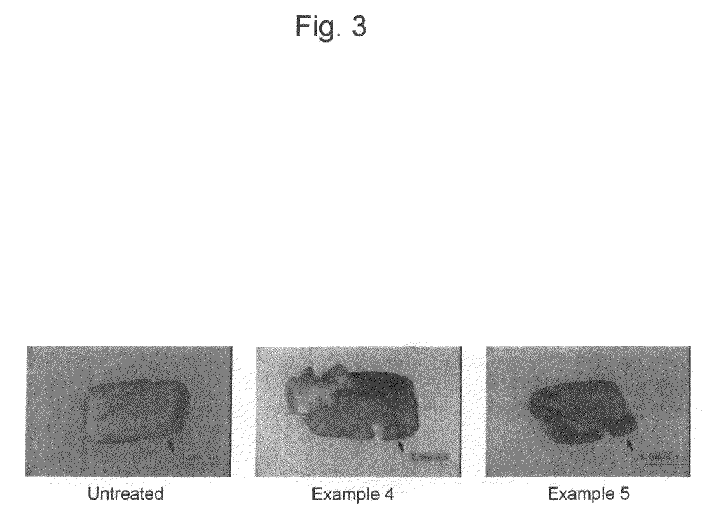

As shown in exterior photos in FIG. 3, the appearance of a seed obtained in Example 5 was closer to that of an untreated seed than that of a seed obtained in Example 4

### Example 6

### Treatment with Naringinase and Almond-Derived β-Glucosidase

Fenugreek seeds (20 g) were added to boiling water (120 g), followed by heating for 5 minutes. Thereafter, seeds were cooled, during which water was added thereto to a total amount of 67 g. Then, the seeds and the water were separated from each other and weighed (12.5 g each).

The above seeds (12.5 g) were treated with 1N hydrochloric acid to have a pH of 4.5. Then, naringinase (2.5 g) was added to the water and the resultant was allowed to stand at 70° C. for 24 hours. Separately, the seeds were treated by a method similar to the above except that almond-derived β-glucosidase (67.5 mg) was added instead of naringinase and the pH was not adjusted. In addition, an untreated sample was prepared for each case.

As a result, both the naringinase-treated sample and the β-glucosidase treated sample obviously had reduced bitter taste compared with the corresponding untreated samples. In addition, there were no remarkable changes in the appearance of the naringinase-treated sample and in that of the β-glucosidase-treated sample. Further, in the case of the naringinase-treated sample, the rate of absorption of eluate was 84%, and in the case of the β-glucosidase-treated sample, the same was 100%. The results indicate that the whole or substantially whole eluate was absorbed by the fenugreek seeds.

### Example 7

### Differences in Bitter-Taste-Reducing Effects Based on Differences in the Amount of Enzyme Added

### Sample 1:

Fenugreek seeds (20 g) were added to boiling water (120 g), followed by heating for 5 minutes. Then, distilled water was added thereto such the total weight of the fenugreek seeds and boiling water was adjusted to 69 g. Then, a 100-fold dilution of an enzyme SPEZYME CP (100 μl) was added thereto, followed by mixing. The resultant was allowed to stand at 35° C. for 5 days.

### Sample 2:

A sample 2 was prepared in a manner similar to the method used for the sample 1 except that a 10-fold dilution of an enzyme SPEZYME CP (100 μl) was added and the resultant was allowed to stand at 35° C. for 2 days.

### Sample 3:

A sample 3 was prepared in a manner similar to the method used for the sample 1 except that an enzyme SPEZYME CP (100 μl) was added and the resultant was allowed to stand at 35° C. for 2 days.

### Sample 4:

A sample 4 was prepared in a manner similar to the method used for the sample 1 except that the total weight of the fenugreek seeds and boiling water was adjusted to 51 g, an enzyme SPEZYME CP (20 ml) was added, and the resultant was allowed to stand at 35° C. for 3 hours.

### Comparative Sample:

A comparative sample was prepared in a manner similar to the method used for the sample 1 except that the total weight of the fenugreek seeds and boiling water was adjusted to 71 g and an enzyme SPEZYME CP was not added.

The above four samples and the comparative sample were examined in terms of bitter taste. Accordingly, each of the four samples obviously had reduced bitter taste compared with the comparative sample. In addition, there were no significant changes in terms of appearance. Further, the rate of absorption of eluate was 100% in the cases of the samples containing the enzyme SPEZYME CP in amounts of 1 μl, 10 μl, and 100 μl and the untreated sample. The same was approximately 47% in the case of the sample containing the enzyme SPEZYME CP in an amount of 20 ml.

### Example 8

### Confirmation of Effects of the Addition of Water in Amounts of 30 Parts by Weight and 60 Parts by Weight Based on 100 Parts by Weight of Fenugreek Seeds

The amount of water added: 30 parts by weight

Water (4.1 g) and an enzyme SPEZYME CP (1.9 ml) were added to fenugreek seeds (20 g) in such order, followed by mixing. The resultant was allowed to stand at 35° C. for 72 hours, during which given amounts of the fenugreek seeds were collected at 3 hours and 72 hours for evaluation. Separately, water (6 g) was added to fenugreek seeds (20 g). The resultant was allowed to stand under the above conditions such that an untreated sample was obtained.

The amount of water added: 60 parts by weight

Water (10.1 g) and an enzyme SPEZYME CP (1.9 ml) were added to fenugreek seeds (20 g) in such order, followed by mixing. The resultant was allowed to stand at 35° C. for 72 hours, during which given amounts of the fenugreek seeds were collected at 3 hours and 72 hours for evaluation. Separately, water (12 g) was added to fenugreek seeds (20 g). The resultant was allowed to stand under the above conditions such that an untreated sample was obtained.

In the cases of the enzyme-treated fenugreek seed samples (amount of water added: 30 parts by weight and 60 parts by weight) that had been allowed to stand for 3 hours, bitter-taste-reducing effects were indistinguishable from those of untreated fenugreek seed samples upon sensory evaluation. However, in the cases of the enzyme-treated fenugreek seed samples (amount of water added: 30 parts by weight and 60 parts by weight) that had been allowed to stand for 72 hours, the bitter taste was obviously reduced to a greater extent than the cases of untreated fenugreek seed samples.

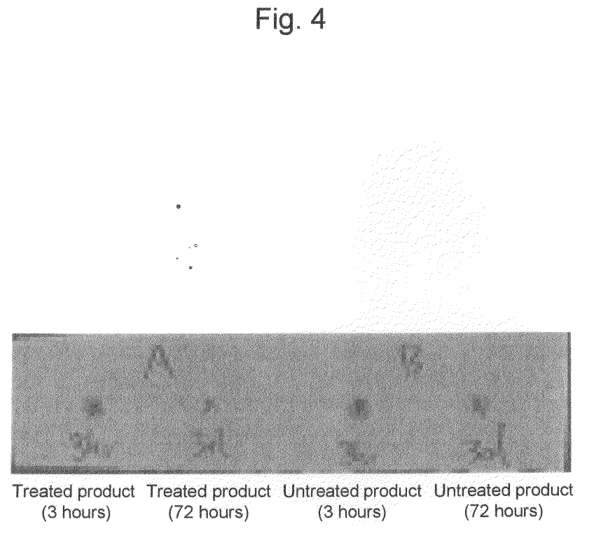

Next, saponin contained in fenugreek seeds was examined. First, 20 grains were collected from among the seeds that had been allowed to stand for 3 hours and the seeds that had been allowed to stand for 72 hours, followed by crude extraction with methanol (2 ml). Each crude extract was added dropwise in a minute amount (1 μl) to a TLC plate (Silica gel 60F245, Merck 1.05715) and dried for formation of spots, followed by staining with an Ehrlich reagent. FIG. 4 shows the results. As a result, in the cases of the samples (amount of water added: 30 parts by weight and 60 parts by weight) that had been allowed to stand for 3 hours, spots were stained, indicating the presence of remaining furostanol saponin. However, in the cases of the samples that had been allowed to stand for 72 hours, substantially no spots of the seed extracts of the enzyme-treated samples were stained. Therefore, it was determined that furostanol saponin did not remain in the samples. Meanwhile, there were no changes in the degree of staining in the untreated sample, even after 72 hours.

In addition, upon comparison between the samples (amount of water added: 30 parts by weight and 60 parts by weight), the sample obtained with the addition of water in an amount of 60 parts by weight exhibited excellent bitter-taste-reducing effects. In addition, there were no significant changes in terms of appearance. Further, the rate of absorption of eluate was 100% in all samples. That is to say, in the cases of the fenugreek seed samples that had been allowed to stand for 3 hours, bitter taste reduction was not confirmed, although substantially complete absorption of water added was confirmed. Meanwhile, in the cases of the fenugreek seed samples that had been allowed to stand for 72 hours, bitter taste reduction was obviously confirmed. Based on this fact, it can be said that the enzyme SPEZYME CP was absorbed by fenugreek seeds together with water added to the seeds such that the enzyme SPEZYME CP became active inside the fenugreek seeds.

### Example 9

### Confirmation of Bitter Taste Reduction in the Case of Adding Water in an Amount of 400 Parts by Weight

Water (78.1 g) and an enzyme SPEZYME CP (1.9 ml) were added to fenugreek seeds (20 g), followed by mixing. The resultant was allowed to stand at 35° C. for 24 hours such that an enzyme-treated sample was prepared. Separately, water (80 g) was added to fenugreek seeds (20 g), followed by mixing. The resultant was allowed to stand at 35° C. for 24 hours such that a non-enzyme-treated sample was prepared. Upon comparison between the thus obtained enzyme-treated sample and the non-enzyme-treated sample, the bitter taste of the enzyme-treated sample was obviously reduced to a greater extent than that of the non-enzyme-treated sample. In addition, there were no significant changes in terms of appearance. Further, the rate of absorption of eluate was 61% in the case of the enzyme-treated sample. However, regarding 4-OH-Ile in the enzyme-treated sample, the 4-OH-Ile content in fenugreek seeds (20 g) was 108 mg and the same in the residual portion of the eluate was 13.2 mg. This suggests that 87.8% of 4-OH-Ile was present in fenugreek seeds in the enzyme-treated sample, indicating that the 4-OH-Ile content decrease due immersion was small.

### Reference Example

### Confirmation of Bitter Taste Reduction in the Case of Adding Water in An Amount of 1000 Parts by Weight

Water (198.1 g) and an enzyme SPEZYME CP (1.9 ml) were added to fenugreek seeds (20 g), followed by mixing. The resultant was allowed to stand at 35° C. for 24 hours such that an enzyme-treated sample was prepared. Separately, water (200 g) was added to fenugreek seeds (20 g), followed by mixing. The resultant was allowed to stand at 35° C. for 24 hours such that a non-enzyme-treated sample was obtained. Upon comparison between the thus obtained enzyme-treated sample and non-enzyme-treated sample, the bitter taste of the enzyme-treated sample was reduced to a greater extent than that of the non-enzyme-treated sample. In addition, the rate of absorption of eluate was 34% in the case of the enzyme-treated sample. However, regarding 4-OH-Ile in the enzyme-treated sample, the 4-OH-Ile content in fenugreek seeds (20 g) was 108 mg and the same in the residual portion of the eluate was 6.4 mg. This suggests that 94.1% of 4-OH-Ile was present in fenugreek seeds in the enzyme-treated sample, indicating that the 4-OH-Ile content decrease due immersion was small. However, in terms of appearance, slight deformation was observed.

### Example 10

### Other Treatment Method

Water (12 g) was added to fenugreek seeds (20 g), followed by heat treatment in an autoclave at 90° C. for 5 minutes. Thereafter, seeds were cooled, during which water was added thereto to a total weight of 69 g. Two such samples were prepared. An enzyme SPEZYME CP (1.9 ml) was added to one of the samples, followed by mixing, and distilled water (1.9 ml) was added to the other sample, followed by mixing. (These samples are referred to as an enzyme-treated sample and an untreated sample.) Thereafter, both samples were allowed to stand at 35° C. for 5 hours. Then, sensory evaluation was carried out and the rate of absorption of eluate was confirmed. As a result, upon sensory evaluation, the bitter taste of the enzyme-treated sample was obviously reduced to a greater extent than that of the non-enzyme-treated sample. Meanwhile, the rate of absorption of eluate in the enzyme-treated sample was 83.8%.

### Example 11

### Other Treatment Method

Water (12 g) was added to fenugreek seeds (20 g), followed by steam heating in an autoclave at 90° C. for 5 minutes. After cooling, the weight of the fenugreek seeds was measured. Upon bitter taste confirmation, the seeds were found to obviously have bitter taste. Thereafter, the fenugreek seeds were washed with tap water, followed by determination of the 4-OH-Ile content. Then, distilled water was added thereto so as to obtain a mixture of the fenugreek seeds and water in a total weight of 69 g. An enzyme SPEZYME CP (1.9 ml) was added thereto, followed by mixing. The resultant was allowed to stand at 35° C. for 3 hours. Upon bitter taste confirmation, it was found that the bitter taste had obviously been reduced. Thereafter, the enzyme-treated fenugreek seeds were washed with water, followed by determination of the 4-OH-Ile content. Further, the seeds were subjected to steam heating at 90° C. for 15 minutes for deactivation of the enzyme SPEZYME CP, followed by another washing with water and determination of the 4-OH-Ile content. Table 2 shows the 4-OH-Ile content results.

TABLE 2

| | | | The 4-OH-Ile content |
|---|---|---|---|
| | The 4-OH-Ile | Standard | (based on the 4-OH-Ile |
| | content in 20 | deviation | content in original |
| | grains (mg/ml) | (mg/ml) | seeds) (%) |
| Original seeds | 0.078 | 0.0043 | 100 |
| Seeds washed with | 0.060 | 0.0007 | 76.9 |
| water after enzyme | | | |
| treatment | | | |
| Seeds washed with | 0.040 | 0.0003 | 51.3 |
| water after enzyme | | | |
| deactivation | | | |

### Example 12

### Other Treatment Method

Fenugreek seeds (20 g) were added to boiling water (120 g), followed by heating for 5 minutes. Then, distilled water was added thereto so as to obtain a mixture of the fenugreek seeds and boiling water in a total weight of 69 g. An enzyme SPEZYME CP (1.9 ml) was added thereto, followed by mixing. The resultant was allowed to stand at 35° C. for 3 hours. Thereafter, the seeds were washed with water and subjected to steam heating at 90° C. for 15 minutes for deactivation of the enzyme SPEZYME CP. The obtained seeds had reduced bitter taste and maintained in their initial appearance.

Next, extraction from 20 grains of the enzyme-treated fenugreek seeds and 20 grains of the untreated fenugreek seeds was carried out with the use of 70% ethanol (v/v) (20 ml), followed by centrifugation at 3000 rpm for 10 minutes. The obtained supernatants were filtered with a 0.45 μM filter such that two different amino acid extracts were produced. Subsequently, in order to determine the amount of amino acids contained in the extract extracted from the enzyme-treated fenugreek seeds, a 80%-dilution solution of the extract extracted from the untreated fenugreek seeds was used as a control for comparison.

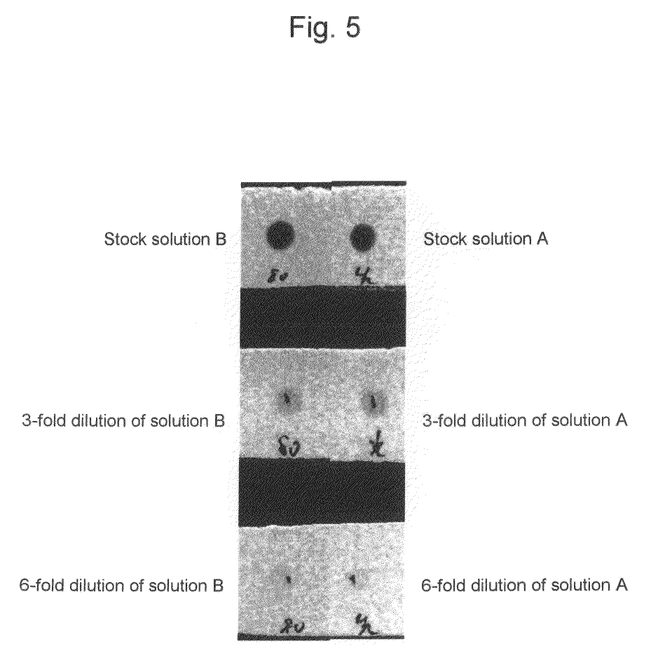

First, the extract extracted from the enzyme-treated fenugreek seeds was designated as “solution A” and the 80%-dilution solution of the extract extracted from the untreated fenugreek seeds was designated as “solution B.” Both solution A and solution B were diluted 3-fold and 6-fold with 70% ethanol (v/v) such that a 3-fold diluted solution and a 6-fold diluted solution of each thereof were prepared. Thereafter, solution A, solution B, and the 3-fold and 6-fold diluted solutions thereof were added dropwise in minute amounts (1 μl each) to a TLC plate (Silica gel 60F245, Merck 1.05715), followed by drying for formation of spots. Then, the spots were stained with ninhydrine. FIG. 5 shows the results. As a result of staining, the degree of staining of the solution A was comparable to that of the solution B at each dilution level. The results showed that the amount of amino acids in the extract extracted from the enzyme-treated fenugreek seeds was substantially equal to the amount of amino acids in the 80%-dilution solution of the extract extracted from the untreated fenugreek seeds. That is, it was found that the amino acid level in the enzyme-treated fenugreek seeds washed with water was maintained at a level corresponding to approximately 80% of the amino acid level in the untreated fenugreek seeds. In addition, as confirmed in Example 1, the amino acid mainly consisted of 4-OH-Ile.

### Example 13

### Other Treatment Methods

Fenugreek seeds (20 g) were added to boiling water (120 g), followed by heating for 5 minutes. Thereafter, distilled water was added thereto so as to obtain a mixture of the fenugreek seeds and boiling water in a total weight of 69 g. Further, an enzyme SPEZYME CP (1.9 ml) was added thereto, followed by mixing. The resultant was allowed to stand at 35° C. for 3 hours. Thereafter, steam heating was carried out at 90° C. for 15 minutes for deactivation of the enzyme SPEZYME CP and the sample was removed at a steam temperature of 80° C., followed by washing of the seeds with water. The seeds had reduced bitter taste and were maintained in appearance.

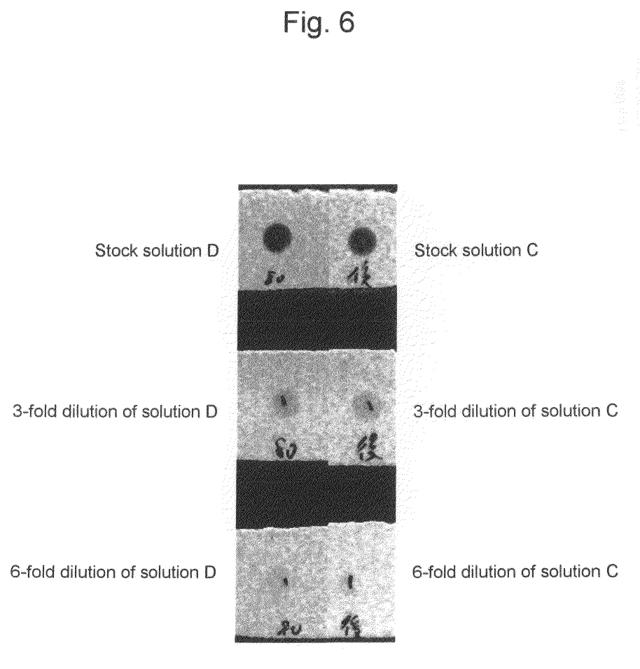

Next, the amount of amino acids in the enzyme-treated fenugreek seeds washed with water was confirmed by the method use in Example 12 except that the extract extracted from the enzyme-treated fenugreek seeds was designated as “solution C” and the 80% dilution solution of the extract extracted from the untreated fenugreek seeds was designated as “solution D.” FIG. 6 shows the results. Consequently, the amino acid level in the enzyme-treated fenugreek seed sample washed with water was maintained at a level corresponding to approximately 80% of the amino acid level in the untreated fenugreek seed sample.

### Example 14

### Germinated Fenugreek Seeds

Distilled water (53.1 ml) and an enzyme SPEZYME CP (1.9 ml) were added to fenugreek seeds (20 g) in such order, followed by mixing. The resultant was allowed to stand in a thermostatic bath at 25° C. for 48 hours such that germinating fenugreek seeds were allowed to absorb 77.6% of the distilled water added thereto. Thus, enzyme-treated fenugreek seeds were obtained. Separately, non-enzyme-treated fenugreek seeds were obtained by adding distilled water thereto and allowing the seeds to stand in a thermostatic bath in a manner similar to the above except that the enzyme was not added thereto. Next, the two obtained germinating fenugreek seed samples were examined in terms of bitter taste. It was found that the bitter taste of the enzyme-treated sample had been obviously reduced to a greater extent than that of the untreated sample.

### Reference Example

The moisture contents of the fenugreek seeds used in Examples 1 to 14 were 10% by mass.

### INDUSTRIAL APPLICABILITY

According to the present invention, fenugreek seeds having reduced bitter taste can be provided without causing significant changes in non-bitter components contained in such fenugreek seeds.

According to the method of the present invention, fenugreek seeds having reduced bitter taste can be used for general purposes for which usual fenugreek seeds can be used.

All publications, patents, and patent applications cited herein are incorporated herein by reference in their entirety.

1. A method for producing fenugreek seeds having reduced bitter taste, comprising the steps of: adding water to fenugreek seeds so as to elute the components of the fenugreek seeds; adding β-glucosidase; and allowing the fenugreek seeds to absorb the components and the β-glucosidase.

2. The method according to claim 1, comprising the steps of: adding water to the fenugreek seeds so as to form a mixture; eluting the components of the fenugreek seeds in the water contained in the mixture; adding β-glucosidase to an eluate obtained by eluting the components in the water contained in the mixture; and allowing the fenugreek seeds to absorb the eluate and β-glucosidase contained in the eluate.

3. The method according to claim 1, comprising the steps of: immersing fenugreek seeds in water by adding water thereto; eluting the components of the fenugreek seeds in the water; separating the fenugreek seeds from an eluate obtained by eluting the components in the water; adding β-glucosidase to the separated eluate; and allowing the fenugreek seeds to absorb the eluate and β-glucosidase contained in the eluate.

4. The method according to claim 1, wherein the step of eluting the components of fenugreek seeds is a step of heating a mixture obtained by adding water to fenugreek seeds.

5. The method according to claim 1, wherein the step of adding β-glucosidase is a step of adding β-glucosidase to the eluate or a step of preliminarily adding β-glucosidase to fenugreek seeds and/or water.

6. The method according to claim 1, wherein the amount of water added is 30 to 600 parts by weight based on 100 parts by weight of fenugreek seeds.

7. The method according to claim 1, wherein the amount of water added is 60 to 400 parts by weight based on 100 parts by weight of fenugreek seeds.

8. The method according to claim 1, further comprising drying the fenugreek seeds absorbing the eluate and β-glucosidase after allowing β-glucosidase to act.

9. The method according to claim 1, further comprising deactivating β-glucosidase after allowing β-glucosidase to act.

10. A food comprising, as a raw material, fenugreek seeds produced by the method according to claim 1.
